(19) United States
(12) Patent Application Publication
(10) Pub. No.: US 2015/0067152 A1
(43) Pub. Date: Mar. 5, 2015

(54) MONITORING SYSTEM, SYSTEM, AND MONITORING METHOD

(71) Applicant: Tatsuya HOSHINO, Kanagawa (JP)

(72) Inventor: Tatsuya HOSHINO, Kanagawa (JP)

(73) Assignee: RICOH COMPANY, LIMITED, Tokyo (JP)

(21) Appl. No.: 14/471,022

(22) Filed: Aug. 28, 2014

(30) Foreign Application Priority Data
Aug. 29, 2013 (JP) 2013-178638
Aug. 26, 2014 (JP) 2014-171950

(51) Int. Cl. H04L 12/26

(52) U.S. Cl. CPC H04L 43/062
USPC 709/224

(57) ABSTRACT

A monitoring system includes an access unit, an access result analyzer, a creator, and an output unit. Based on access data that defines an order of one or more access processes necessary for receiving a service and access information used in the respective access processes, the access unit accesses a service providing system that provides the service and acquires access results of the respective access processes. The access result analyzer analyzes the access results and generates access result information on the respective access processes. Based on the pieces of access result information, the creator creates a report on whether the service is capable of being provided. The output unit outputs the report.

### CROSS-REFERENCE TO RELATED APPLICATIONS

The present application claims priority to and incorporates by reference the entire contents of Japanese Patent Application No. 2013-178638 filed in Japan on Aug. 29, 2013 and Japanese Patent Application No. 2014-171950 filed in Japan on Aug. 26, 2014.

### BACKGROUND OF THE INVENTION

1. Field of the Invention

The present invention relates to a monitoring system, a system, and a monitoring method.

2. Description of the Related Art

Technologies have so far been known that monitor a service providing system that provides Web services, such as cloud services (refer to Japanese Patent Application Laid-open No. 2012-113556, for example). Such technologies generally monitor whether each server in a group of servers constituting the service providing system is operable, based on the status of hardware resources, such as the use status of processors and memories thereof and the use status of a network.

The conventional technologies as described above merely indirectly monitor whether a service can be provided based on whether the servers constituting the service providing system can operate, and have not been able to directly monitor whether the service can be provided.

Therefore, there is a need for a monitoring system, a system, and a monitoring method that are capable of directly monitoring whether a service can be provided.

### SUMMARY OF THE INVENTION

According to an embodiment, a monitoring system includes an access unit, an access result analyzer, a creator, and an output unit. Based on access data that defines an order of one or more access processes necessary for receiving a service and access information used in the respective access processes, the access unit accesses a service providing system that provides the service and acquires access results of the respective access processes. The access result analyzer analyzes the access results and generates access result information on the respective access processes. Based on the pieces of access result information, the creator creates a report on whether the service is capable of being provided. The output unit outputs the report.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of the configuration of a system including a monitoring system according to a first embodiment of the present invention;

FIG. 2 is a block diagram illustrating an example of the configuration of the monitoring system according to the first embodiment;

FIG. 3 is a diagram illustrating an example of an HTTP request used for an access process called “login” according to the first embodiment;

FIG. 4 is a diagram illustrating an example of an HTTP response to the access process called “login” according to the first embodiment;

FIG. 5 is a diagram illustrating an example of a format of access result information according to the first embodiment;

FIG. 6 is a diagram illustrating an example of the access result information according to the first embodiment, indicating that access has been successful;

FIG. 7 is a diagram illustrating an example of the access result information according to the first embodiment, indicating that the access has failed;

FIG. 8 is a diagram illustrating an example of a report according to the first embodiment;

FIG. 9 is a sequence diagram illustrating an example of a group of access processes performed by the monitoring system according to the first embodiment;

FIG. 10 is flowchart illustrating an example of an analysis process performed by the monitoring system according to the first embodiment;

FIG. 11 is a block diagram illustrating an example of the configuration of a system including a monitoring system according to a second embodiment of the present invention;

FIG. 12 is a block diagram illustrating an example of the configuration of the monitoring system according to the second embodiment;

FIG. 13 is a diagram illustrating an example of an HTTP request used for an access process called “acquire user information” according to the second embodiment;

FIG. 14 is a block diagram illustrating an example of the configuration of a service providing system according to the second embodiment;

FIG. 15 is a diagram illustrating an example of information stored in a memory system according to the second embodiment;

FIG. 16 is a diagram illustrating an example of a search request sent to the memory system by a searcher according to the second embodiment;

FIG. 17 is a diagram illustrating an example of a search response to the search request according to the second embodiment;

FIG. 18 is a diagram illustrating an example of error notification information according to the second embodiment;

FIG. 19 is a sequence diagram illustrating an example of access processes performed by the system according to the second embodiment;

FIG. 20 is a sequence diagram illustrating an example of search and output processes performed by the monitoring system according to the second embodiment;

FIG. 21 is a diagram illustrating an example of a table according to Modification 3;

FIG. 22 is a diagram illustrating an example of error information according to Modification 4; and

FIG. 23 is a diagram illustrating an example of the hardware configuration of each system according to the embodiments.

### DETAILED DESCRIPTION OF THE PREFERRED EMBODIMENTS

Embodiments of a monitoring system, a system, and a monitoring method according to the present invention will be described below in detail with reference to the accompanying drawings.

### First Embodiment

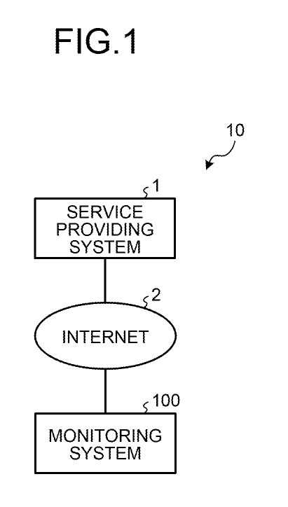

FIG. 1 is a block diagram illustrating an example of the configuration of a system 10 including a monitoring system 100 according to a first embodiment of the present invention. As illustrated in FIG. 1, the system 10 includes a service providing system 1 and the monitoring system 100. The service providing system 1 and the monitoring system 100 are connected via the Internet 2.

The service providing system 1 provides Web services, such as cloud services, via the Internet 2, and is constituted by one or more servers. While the first embodiment will be described by exemplifying a case in which the service providing system 1 provides a cloud printing service, the service provided is not limited to this. Examples of services that can be provided by the service providing system 1 include, but are not limited to, various cloud services (Web services in a broad sense), such as storage services.

The monitoring system 100 monitors whether a service can be provided by the service providing system 1, and may be constituted by one computer or a plurality of computers.

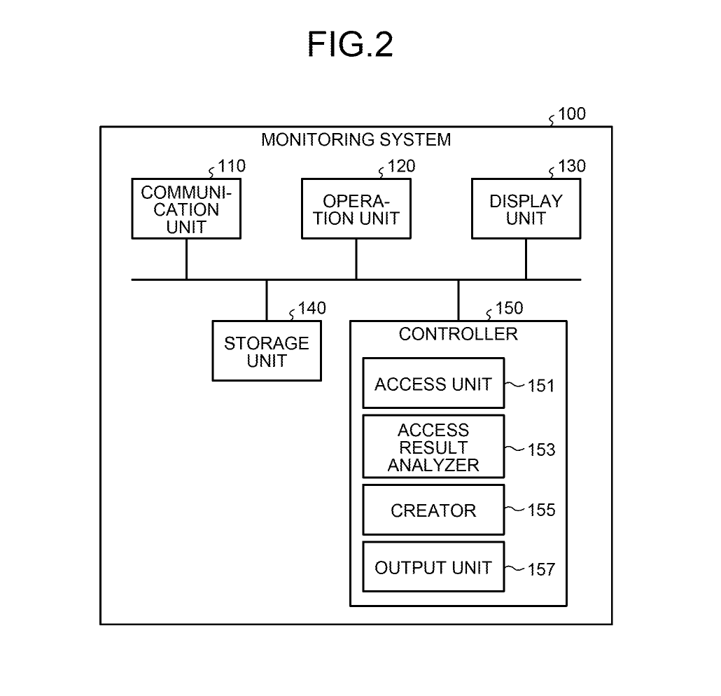

FIG. 2 is a block diagram illustrating an example of the configuration of the monitoring system 100 according to the first embodiment. As illustrated in FIG. 2, the monitoring system 100 includes a communication unit 110, an operation unit 120, a display unit 130, a storage unit 140, and a controller 150.

The communication unit 110 communicates with external systems, such as the service providing system 1, via the Internet 2, and can be implemented by a communication device, such as a network interface card (NIC).

The operation unit 120 is used for various kinds of control input, and can be implemented by input devices, such as a keyboard, a mouse, a touchpad, and a touchscreen.

The display unit 130 displays various screens, and can be implemented by a display device, such as a liquid crystal display or a touch panel display.

The storage unit 140 stores various computer programs, such as a monitoring program executed by the monitoring system 100, and data used for various processes performed by the monitoring system 100. The storage unit 140 can be implemented by at least one of storage devices capable of magnetically, optically, or electrically storing data, such as a hard disk drive (HDD), a solid state drive (SSD), a memory card, an optical disc, and a random access memory (RAM).

The controller 150 controls respective units of the monitoring system 100, and can be implemented by a control device, such as a central processing unit (CPU). The controller 150 includes an access unit 151, an access result analyzer 153, a creator 155, and an output unit 157. The controller 150 implements the access unit 151, the access result analyzer 153, the creator 155, and the output unit 157 as software by starting (executing) the monitoring program stored in the storage unit 140.

Based on access data that defines the order of one or more access processes necessary for receiving a service and access information used in the respective access processes, the access unit 151 accesses the service providing system 1 that provides the service.

The access unit 151 only needs to be a software module that can access the service providing system 1 through a predetermined protocol, that is, that can communicate with the service providing system 1 through a predetermined protocol. Examples of the access unit 151 include, but are not limited to, tools, such as Apache JMeter, for measuring loads of Web services and the curl command of Linux (registered trademark). While the first embodiment will be described by exemplifying a case in which the predetermined protocol is a Hypertext Transfer Protocol (HTTP), the protocol is not limited to this, but various protocols can be employed.

The access data includes, in the category thereof, data that defines the order of a series of access processes (hereinafter, may be called “scenario”) in a use case of a service and access information used in the respective access processes. For example, in the case of the cloud printing, the access data includes, in the category thereof, data that defines five access processes (scenario of the cloud printing) called “login”, “send document for printing”, “check document for printing”, “request printing”, and “logout” as a use case of the cloud printing, and access information used in the respective access processes. In the first embodiment, the respective access processes are performed through HTTP communication, so that the access information is an HTTP request. While the first embodiment assumes that the access information is stored in the storage unit 140, the access information is not limited to be so.

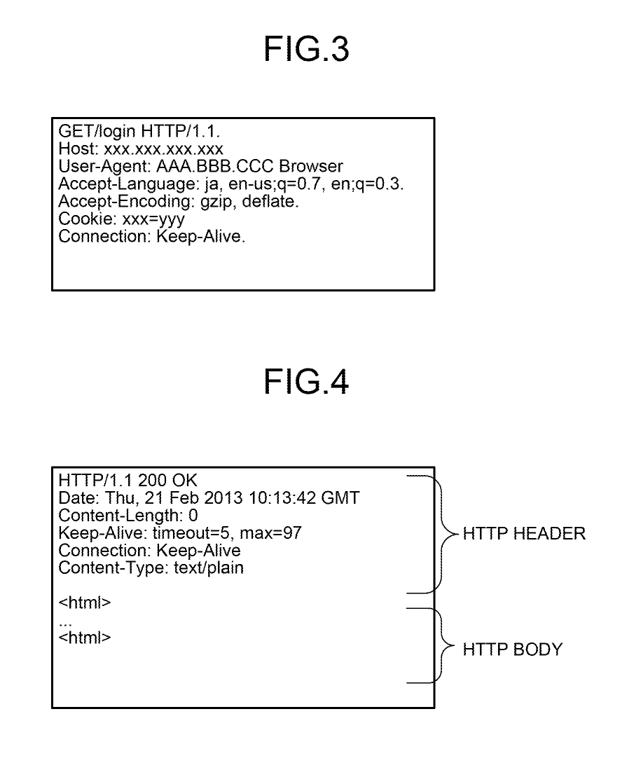

FIG. 3 is a diagram illustrating an example of the HTTP request used for the access process called “login” according to the first embodiment. While not depicted in the example illustrated in FIG. 3, the uniform resource locator (URL) of an access destination (in detail, a login screen of the cloud printing service provided by the service providing system 1) is also included in the HTTP request.

The information of the HTTP request need not be entirely predefined in the access data. At least a part of the information may be predefined, and the other information may be generated when the HTTP request is sent.

After gaining access to the service providing system 1 based on the access data, the access unit 151 acquires access results of the respective access processes. In the first embodiment, the respective access processes are performed through the HTTP communication as described above, so that the access results are HTTP responses.

FIG. 4 is a diagram illustrating an example of the HTTP response to the access process called “login” according to the first embodiment. The example illustrated in FIG. 4 illustrates the HTTP response when the login has been successful.

The access result analyzer 153 analyzes the access results acquired by the access unit 151, then generates access result information on the respective access processes, and stores one or more pieces of generated access result information as a log(s) in the storage unit 140.

Specifically, the access result analyzer 153 determines whether each of the access results corresponds to a predefined access result. In the first embodiment, because the respective access processes are performed through the HTTP communication as described above, the access result analyzer 153 determines whether a status code (“200” in the example illustrated in FIG. 4) included in the HTTP header of the HTTP response corresponds to a predefined status code (status code obtained when access is successful), or determines whether the HTTP body of the HTTP response includes a predefined keyword.

For example, in the case of the access process called “login”, suppose that the HTTP body of the HTTP response includes a keyword “welcome”. In this case, the access result analyzer 153 determines whether the HTTP body includes the keyword “welcome”. The predefined keyword included in the HTTP body is defined depending on the contents of the cloud service provided by the service providing system 1 and the access processes.

If the result of the determination indicates that the access result corresponds to the predefined access result, the access result analyzer 153 generates access result information indicating that the access has been successful; or if the access result does not correspond to the predefined access result, the access result analyzer 153 generates access result information indicating that the access has failed.

While the first embodiment assumes that the access result analyzer 153 generates the access result information in a comma separated value (CSV) format and stores it in the storage unit 140, the data format of the access result information is not limited to this.

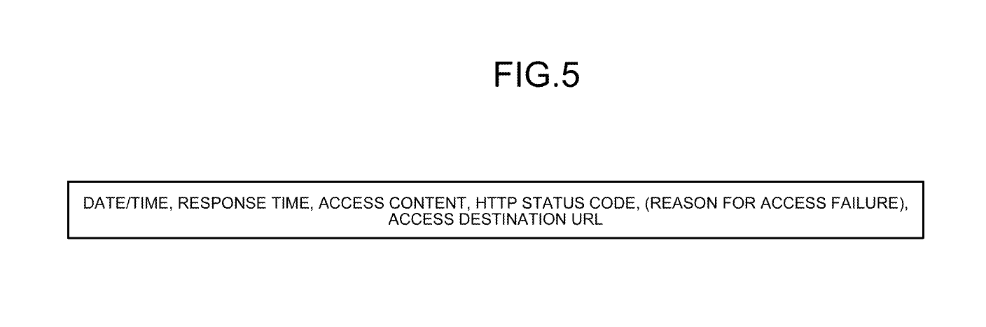

FIG. 5 is a diagram illustrating an example of a format of the access result information according to the first embodiment. In the example illustrated in FIG. 5, the access result information includes date and time, a response time, an access content, an HTTP status code, the reason for access failure, and an access destination URL.

The date and time represent the date and time when the access has been made. The response time represents the time from sending the HTTP request until receiving the HTTP response. The access content represents the content of the access process (such as “login” or “logout”). The HTTP status code represents the status code (such as “200 (OK)” or “404 (not found)”) included in the HTTP header of the HTTP response. The reason for access failure represents the reason why the access has failed, and is generated when the access result analyzer 153 generates the access result information indicating the access failure based on the determination result of the comparison between the access result acquired by the access unit 151 and the predefined access result. The access destination URL represents the URL of the access destination. The date and time, the response time, the access content, the HTTP status code, and the access destination URL are included in the access result acquired by the access unit 151.

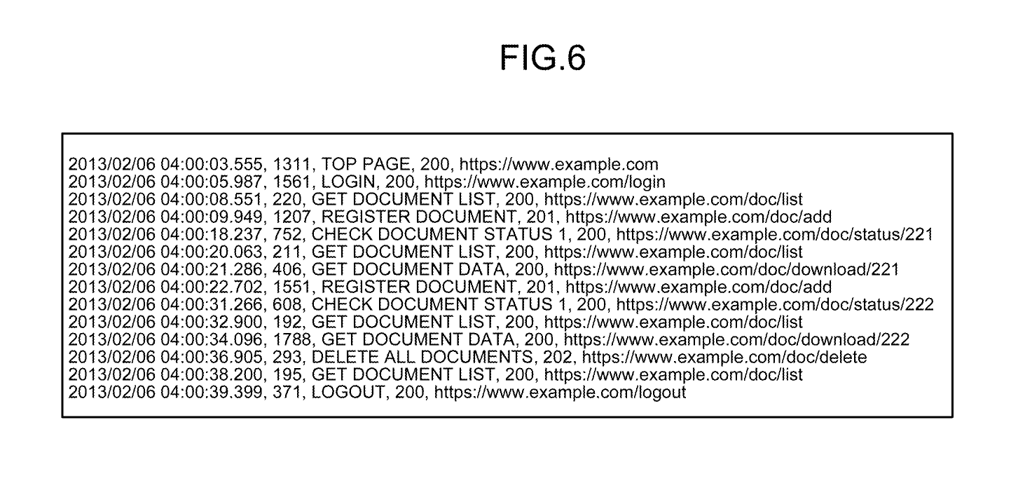

FIG. 6 is a diagram illustrating an example of the access result information according to the first embodiment, the example indicating that the access has been successful and being constituted by the date and time, the response time, the access content, the HTTP status code, and the access destination URL.

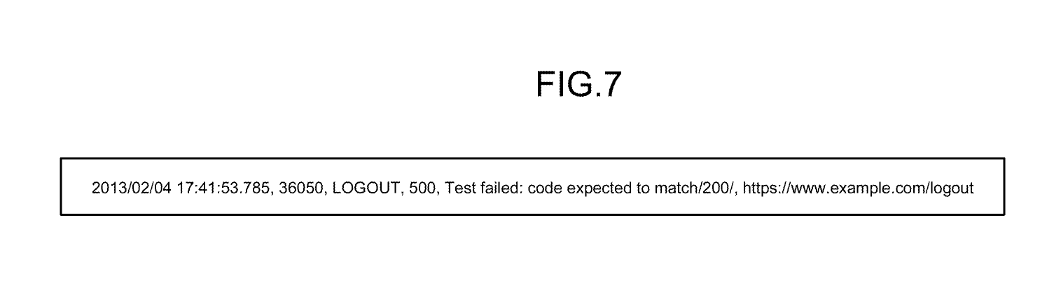

FIG. 7 is a diagram illustrating an example of the access result information according to the first embodiment, the example, indicating that the access has failed and being constituted by the date and time, the response time, the access content, the HTTP status code, the reason for access failure, and the access destination URL. In the example illustrated in FIG. 7, the result of the determination as to whether the status code included in the HTTP header of the HTTP response corresponds to the predefined status code (“200” in the example illustrated in FIG. 7) indicates that the status code included in the HTTP header is not “200”, and accordingly, the access result analyzer 153 sets the reason for access failure to “Test failed: code expected to match /200/”.

Based on the pieces of access result information generated by the access result analyzer 153, the creator 155 creates a report on whether the service can be provided. Specifically, the creator 155 creates the report in which the pieces of access result information are arranged in chronological order. As a result, the report indicates that the service can be provided if the pieces of access result information include no access result information indicating that the access has failed, or indicates that the service cannot be provided if the pieces of access result information include the access result information indicating that the access has failed.

In the first embodiment, the creator 155 creates the report by acquiring one or more pieces of access result information from the storage unit 140, arranging the acquired access result information in chronological order, and converting the format of the report into a HyperText Markup Language (HTML) format. The format of the report is, however, not limited thereto.

In the first embodiment, if one or more pieces of access result information include the access result information indicating that the access has failed, the creator 155 creates, as the report, a report in which the access result information indicating that the access has failed is emphasized. For example, the creator 155 creates a report in which the access result information indicating that the access has failed is distinguished from the access result information indicating that the access has been successful by using different colors. This can make the access result information indicating that the access has failed easily identifiable.

The output unit 157 outputs the report created by the creator 155. For example, the output unit 157 may output the report created by the creator 155 to be displayed on a web browser of the display unit 130, or may output the report via the communication unit 110 to be displayed on a web browser of an administrator terminal or the like, which is not illustrated.

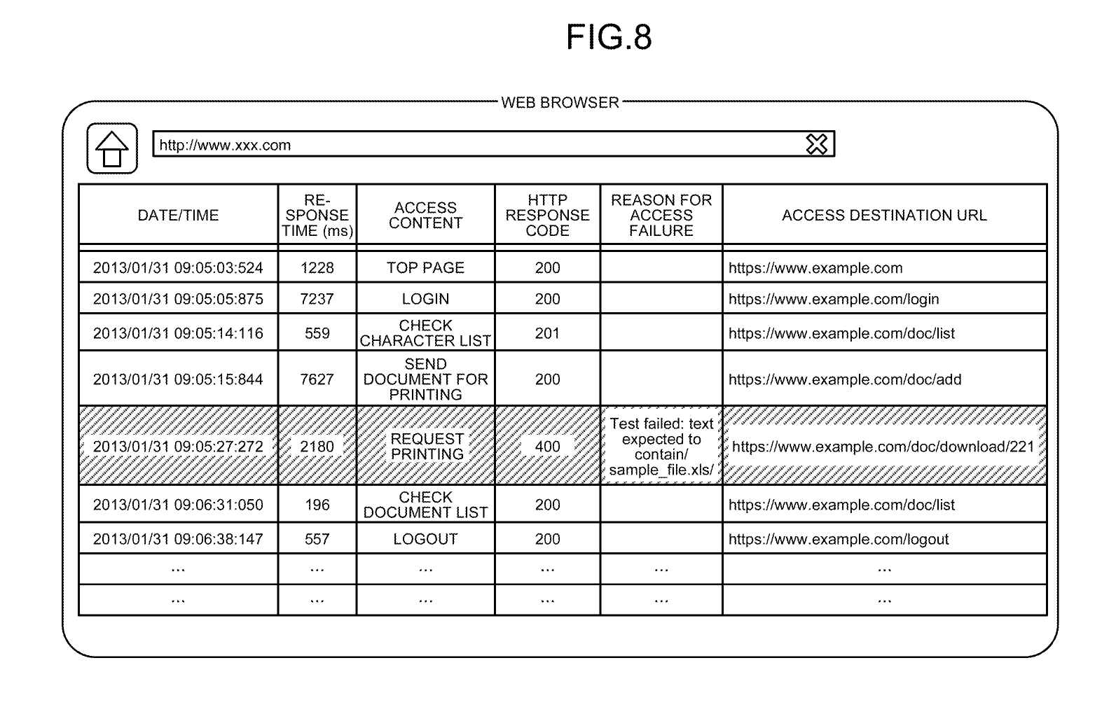

FIG. 8 is a diagram illustrating an example of the report according to the first embodiment. In the example illustrated in FIG. 8, a plurality of pieces of the access result information are arranged in chronological order, and the access result information indicating that the access has failed is displayed so as to be distinguished from the access result information indicating that the access has been successful by using different colors.

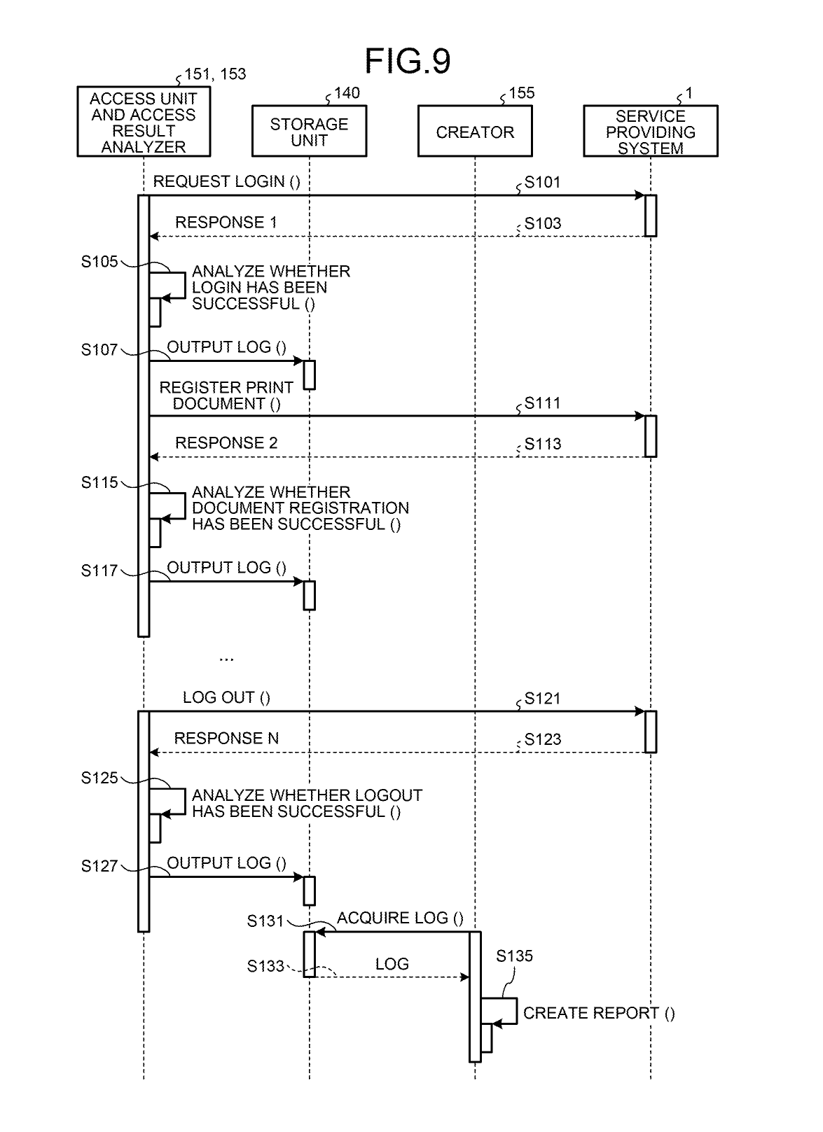

FIG. 9 is a sequence diagram illustrating an example of a group of access processes performed by the monitoring system 100 according to the first embodiment, illustrating the sequence of the series of access processes along the use case of the cloud printing.

First, based on the access data that defines the scenario of the cloud printing and the access information used in the respective access processes constituting the scenario, the access unit 151 sends an HTTP request to request a login to the service providing system 1 (Step S101), and acquires an HTTP response (response 1) to the HTTP request from the service providing system 1 (Step S103).

Then, the access result analyzer 153 analyzes whether the login has been successful by determining whether the acquired HTTP response (response 1) corresponds to a predefined HTTP response (Step S105), then generates access result information according to the result of the analysis, and outputs (stores) the access result information as a log in the storage unit 140 (Step S107).

Then, based on the access data, the access unit 151 sends an HTTP request for print document registration to the service providing system 1 (Step S111), and acquires an HTTP response (response 2) to the HTTP request from the service providing system 1 (Step S113).

Then, the access result analyzer 153 analyzes whether the document registration has been successful by determining whether the acquired HTTP response (response 2) corresponds to the predefined HTTP response (Step S115), then generates access result information according to the result of the analysis, and outputs (stores) the access result information as a log in the storage unit 140 (Step S117).

Thereafter, the monitoring system 100 repeats the same processing along the scenario of the cloud printing.

Lastly, based on the access data, the access unit 151 sends an HTTP request for logout to the service providing system 1 (Step S121), and acquires an HTTP response (response N) to the HTTP request from the service providing system 1 (Step S123).

Then, the access result analyzer 153 analyzes whether the logout has been successful by determining whether the acquired HTTP response (response N) corresponds to the predefined HTTP response (Step S125), then generates access result information according to the result of the analysis, and outputs (stores) the access result information as a log in the storage unit 140 (Step S127).

Then, the creator 155 acquires one or more logs from the storage unit 140 (Steps S131 and S133), then arranges the acquired logs in chronological order, and converts the format of the result into the HTML format to create a report (Step S135).

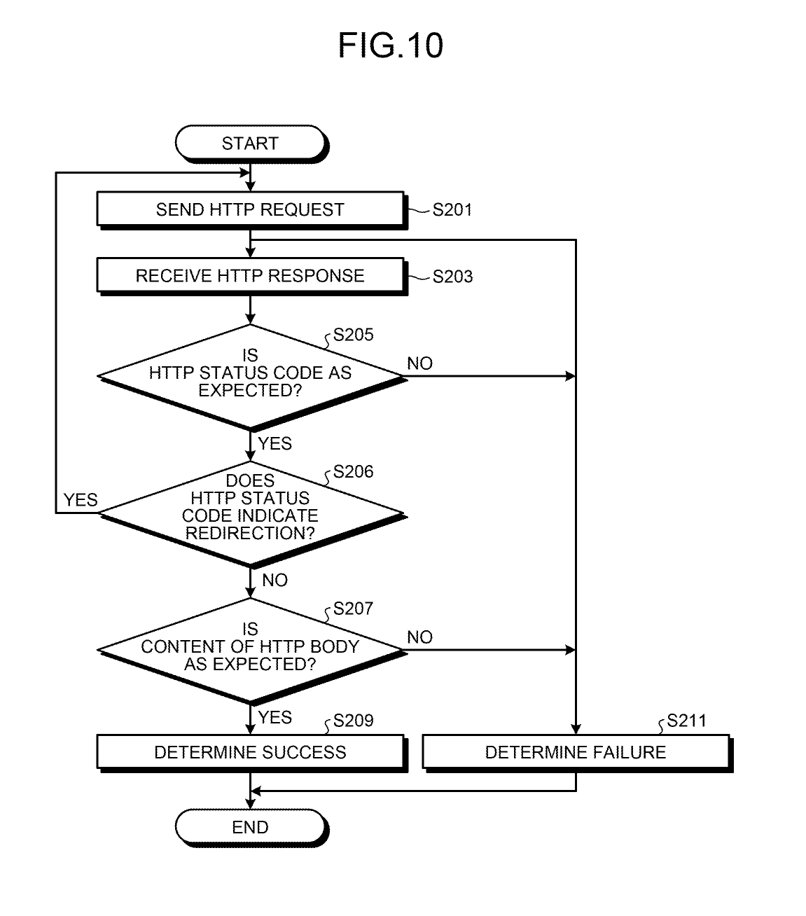

FIG. 10 is flowchart illustrating an example of the analysis process performed by the monitoring system 100 according to the first embodiment.

First, the access unit 151 sends an HTTP request for an access process to the service providing system 1 (Step S201), and receives an HTTP response to the HTTP request from the service providing system 1 (Step S203). If the access unit 151 has received no HTTP response within a certain time, the access result analyzer 153 determines that the access has failed (Step S211), and generates the access result information indicating that the access has failed.

Then, the access result analyzer 153 determines whether the HTTP status code of the received HTTP response corresponds to an expected status code (status code obtained when access is successful) (Step S205). If not (No at Step S205), the access result analyzer 153 determines that the access has failed (Step S211), and generates the access result information indicating that the access has failed.

If the HTTP status code corresponds to the expected status code (Yes at Step S205), the access result analyzer 153 determines whether the HTTP status code indicates redirection (Step S206). If so (Yes at Step S206), the process returns to Step S201, and the access unit 151 accesses (sends an HTTP request to) the redirected destination (the URL of the redirected destination specified in the HTTP response).

If the HTTP status code does not indicate redirection (No at Step S206), the access result analyzer 153 determines whether the content of the HTTP body is as expected, that is, whether the HTTP body includes an expected keyword (Step S207). If not (No at Step S207), the access result analyzer 153 determines that the access has failed (Step S211), and generates the access result information indicating that the access has failed.

If the content of the HTTP body is as expected (Yes at Step S207), the access result analyzer 153 determines that the access has been successful (Step S209), and generates the access result information indicating that the access has been successful.

As described above, in the first embodiment, the monitoring system defines, as access data, the data to be sent when a series of access processes is performed to the service providing system for a user to receive a cloud service therefrom; and based on the access data, the monitoring system performs the series of access processes, then analyzes the access results, and creates the report on whether the service can be provided.

As a result, the first embodiment can directly monitor whether the service can be provided by the service providing system, instead of monitoring, in a conventional way, whether each server constituting the service providing system is operable based on the hardware resource of the server so as to indirectly monitor whether the service can be provided. In other words, the first embodiment can monitor whether the service can be provided from the standpoint of the user, that is, at the service level.

As a result, the first embodiment can prevent the service providing system from being determined, in a conventional way, to be incapable of providing the service because some server of a server group constituting the service providing system cannot operate although the service providing system can provide the service, and thus can improve accuracy of the determination as to whether the service can be provided.

### Second Embodiment

In a second embodiment of the present invention, an example will be described in which the user can understand where error have occurred in a service providing system. The following mainly describes differences from the first embodiment. Components having the same functions as those of the first embodiment will be given the same names and reference numerals as those of the first embodiment, and description thereof will be omitted.

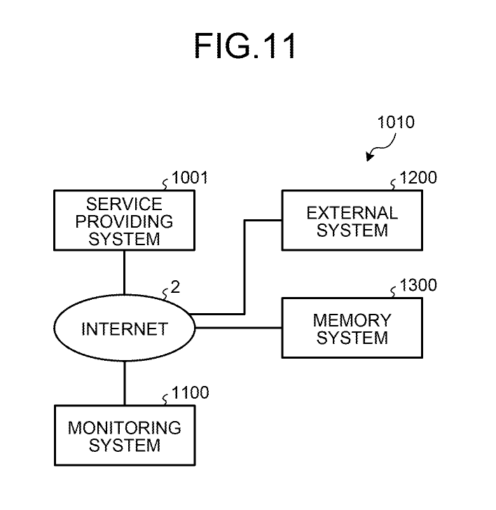

FIG. 11 is a block diagram illustrating an example of the configuration of a system 1010 including a monitoring system 1100 according to the second embodiment. As illustrated in FIG. 11, the system 1010 further includes an external system 1200 and a memory system 1300 (an example of an error storage unit). The external system 1200 and the memory system 1300 are connected to the Internet 2.

A database system is exemplified as the external system 1200, which may be any system that performs any processing. The external system 1200 is constituted by one or more servers.

Examples of the memory system 1300 include, but are not limited to, storage systems. The memory system 1300 is constituted by one or more servers.

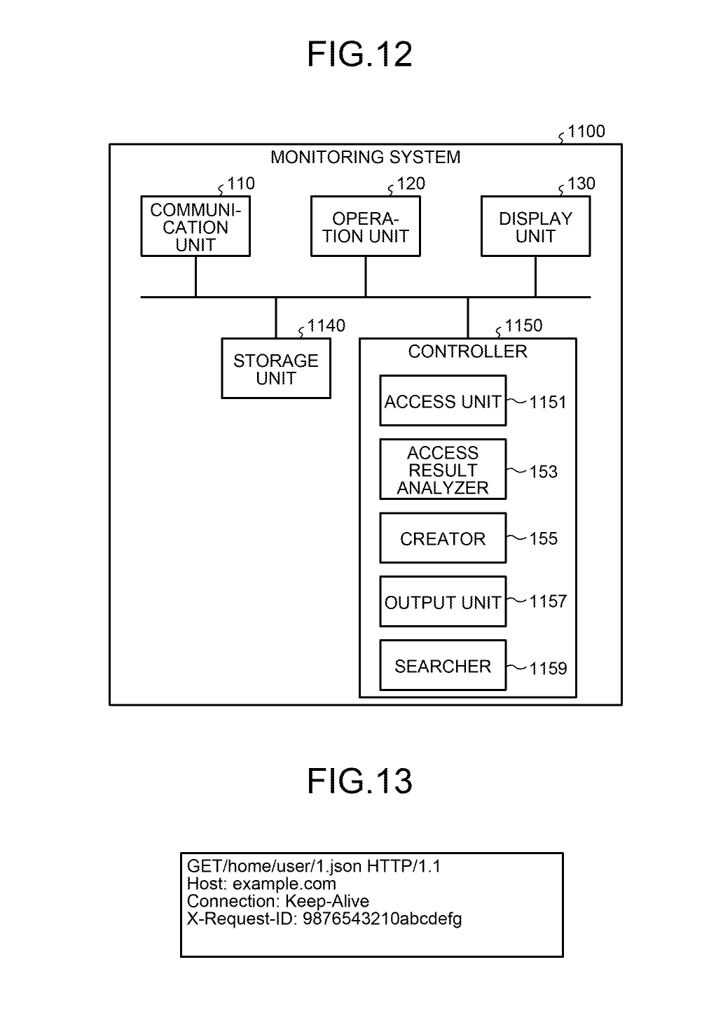

FIG. 12 is a block diagram illustrating an example of the configuration of the monitoring system 1100 according to the second embodiment. As illustrated in FIG. 12, the monitoring system 1100 differs from the monitoring system of the first embodiment in having a storage unit 1140 and in having an access unit 1151, an output unit 1157, and a searcher 1159 of a controller 1150.

The access unit 1151 generates access process identification information that identifies an access process, and performs the access process using the access process identification information and the access information used in the access process. The second embodiment also assumes that each access process is performed through the HTTP communication, and that the access information is an HTTP request.

The access process identification information is an identifier generated when the access process is performed by the access unit 1151, and the content thereof is assumed to change each time each access process is performed. Hence, using the access process identification information allows the access process to be identified even when the same access process (HTTP request) is performed at different times.

FIG. 13 is a diagram illustrating an example of the HTTP request used for an access process called “acquire user information” according to the second embodiment. The HTTP request illustrated in FIG. 13 is an HTTP request generated by adding an X-Request-ID (an example of the access process identification information) generated by the access unit 1151 to an HTTP request stored in the storage unit 1140.

A service providing system 1001, the external system 1200, and the memory system 1300 will be described. While the second embodiment will be described by exemplifying a case in which one server constitutes the service providing system 1001, the constitution is not limited to this.

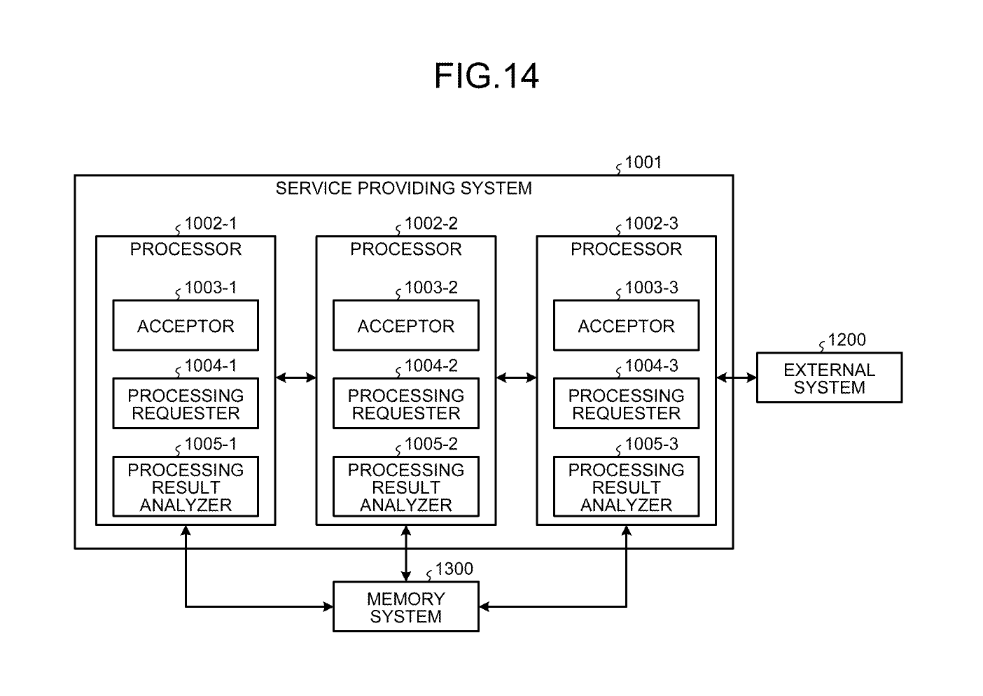

FIG. 14 is a block diagram illustrating an example of the configuration of the service providing system 1001 according to the second embodiment. As illustrated in FIG. 14, the service providing system 1001 includes processors 1002-1 to 1002-3.

The processor 1002-1 includes an acceptor 1003-1, a processing requester 1004-1, and a processing result analyzer 1005-1. The processor 1002-2 includes an acceptor 1003-2, a processing requester 1004-2, and a processing result analyzer 1005-2. The processor 1002-3 includes an acceptor 1003-3, a processing requester 1004-3, and a processing result analyzer 1005-3.

In the following description, in some cases, the processors 1002-1 to 1002-3 will each be simply called a processor 1002 when they need not be distinguished from one another; the acceptors 1003-1 to 1003-3 will each be simply called an acceptor 1003 when they need not be distinguished from one another; the processing requesters 1004-1 to 1004-3 will each be simply called a processing requester 1004 when they need not be distinguished from one another; and the processing result analyzers 1005-1 to 1005-3 will each be simply called a processing result analyzer 1005 when they need not be distinguished from one another.

While the second embodiment will be described by exemplifying a case in which the number of processors 1002 is three, the number is not limited to this, but may be any number more than one.

The processors 1002-1 to 1002-3 have a hierarchical structure. The second embodiment assumes that the processor 1002-1 is positioned at the highest hierarchy level, the processor 1002-2 is positioned at the highest hierarchy next to the processor 1002-1, and the processor 1002-3 is positioned at the highest hierarchy next to the processor 1002-2. However, the hierarchy level is not limited thereto.

The acceptor 1003 accepts an access process from the monitoring system 1100, or a processing request from one of the processors 1002 positioned at the higher hierarchy level than the acceptor 1003 itself.

In the second embodiment, the processors 1002-1 to 1002-3 have the above-described hierarchical structure. Hence, the acceptor 1003-1 accepts the access process from the monitoring system 1100; the acceptor 1003-2 accepts the processing request from the processor 1002-1; and the acceptor 1003-3 accepts the processing request from the processor 1002-2. The processing request is an HTTP request in the same manner as in the case of the access process, but is not limited to this.

Based on the access process or the processing request accepted by the acceptor 1003, the processing requester 1004 issues a processing request including the access process identification information included in the access process or the processing request to one of the processors 1002 positioned at a lower hierarchy level than the processing requester 1004 itself or to the external system 1200, and obtains a processing result.

In the second embodiment, the processors 1002-1 to 1002-3 have the above-described hierarchical structure. As described above, the acceptor 1003-1 accepts an access process from the monitoring system 1100. This causes the processing requester 1004-1 to generate a processing request for processing the access process from the monitoring system 1100 based on the access process therefrom, add the access process identification information included in the access process to the processing request, issue the processing request with the access process identification information added thereto to the processor 1002-2, obtain a processing result from the processor 1002-2, and then return it to the monitoring system 1100.

As described above, the acceptor 1003-2 accepts a processing request from the processor 1002-1. This causes the processing requester 1004-2 to generate a processing request for dealing with the processing request from the processor 1002-1 based on the processing request therefrom, add the access process identification information included in the processing request from the processor 1002-1 to the generated processing request, issue the processing request with the access process identification information added thereto to the processor 1002-3, obtain a processing result from the processor 1002-3, and then return it to the processor 1002-1.

As described above, the acceptor 1003-3 accepts a processing request from the processor 1002-2. This causes the processing requester 1004-3 to generate a processing request for dealing with the processing request from the processor 1002-2 based on the processing request therefrom, add the access process identification information included in the processing request from the processor 1002-2 to the generated processing request, issue the processing request with the access process identification information added thereto to the external system 1200, obtain a processing result from the external system 1200, and then return it to the processor 1002-2.

The processing result analyzer 1005 analyzes the returned processing result, and if the processing result indicates that the processing has failed, stores, in the memory system 1300, error information in which the processing result, the processing request issued to obtain the processing result, transmission source information indicating the transmission source of the processing request, and transmission destination information indicating the transmission destination of the processing request are associated with one another. The same method as that of the access result analyzer 153 according to the first embodiment only needs to be employed as a method for analyzing whether the processing result indicates that the processing has been successful or the processing has failed.

The processing result analyzer 1005-1 analyzes the processing result returned from the processor 1002-2, and if the processing result indicates that the processing has failed, stores, in the memory system 1300, error information in which the processing result, the processing request issued to obtain the processing result, transmission source information indicating the processor 1002-1, and transmission destination information indicating the processor 1002-2 are associated with one another.

The processing result analyzer 1005-2 analyzes the processing result returned from the processor 1002-3, and if the processing result indicates that the processing has failed, stores, in the memory system 1300, error information in which the processing result, the processing request issued to obtain the processing result, transmission source information indicating the processor 1002-2, and transmission destination information indicating the processor 1002-3 are associated with one another.

The processing result analyzer 1005-3 analyzes the processing result returned from the external system 1200, and if the processing result indicates that the processing has failed, stores, in the memory system 1300, error information in which the processing result, the processing request issued to obtain the processing result, transmission source information indicating the processor 1002-3, and transmission destination information indicating the external system 1200 are associated with one another.

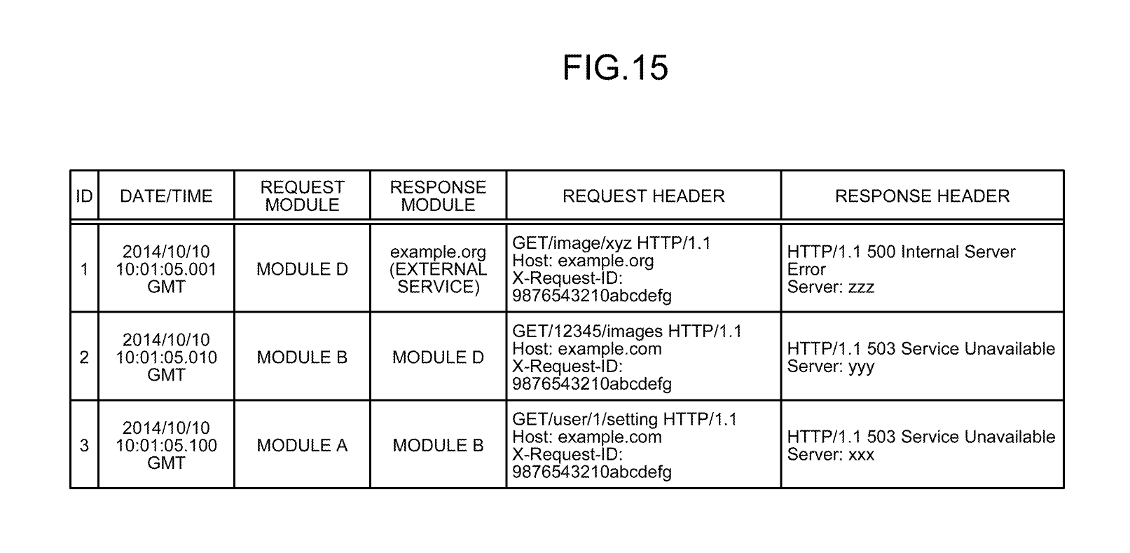

FIG. 15 is a diagram illustrating an example of the information stored in the memory system 1300 according to the second embodiment. In the example illustrated in FIG. 15, dates and times, request modules (examples of the transmission source information), response modules (examples of the transmission destination information), request headers (examples of the processing request), and response headers (examples of the processing result) are stored.

In the example illustrated in FIG. 15, the module A represents the processor 1002-1; the module B represents the processor 1002-2; the module D represents the processor 1002-3; and the external service represents the external system 1200.

In the example illustrated in FIG. 15, information of headers of both the requests and the responses is saved, but information of bodies thereof is not saved. The reason is as follows: The information of bodies tends to be large in size, so that saving the information of bodies can reduce the available storage capacity of the memory system 1300. Thus, cases can be considered in which saving the information of bodies is undesirable from the viewpoint of security.

In the example illustrated in FIG. 15, the processor 1002-1 has issued a processing request called “acquire setting information of user 1” to the processor 1002-2 in order to deal with an access process called “acquire user information”; the processor 1002-2 has issued a processing request called “acquire image with ID ‘12345’” to the processor 1002-3 in order to deal with the processing request called “acquire setting information of user 1”; and the processor 1002-3 has issued a processing request called “acquire image” to the external system 1200 in order to deal with the processing request called “acquire image with ID ‘12345’”. The processor 1002-3 has failed in acquiring the image from the external system 1200, and as a result, all the processing results have resulted in failure.

The description returns to the explanation of the monitoring system 1100.

The searcher 1159 searches the memory system 1300 for one or more pieces of error information associated with the access process identification information. Specifically, if the result of the analysis by the access result analyzer 153 shows that any of the pieces of access result information indicates that the access has failed, the searcher 1159 searches the memory system 1300 for one or more pieces of error information including the access process identification information of the access process whose access result information indicates that the access has failed.

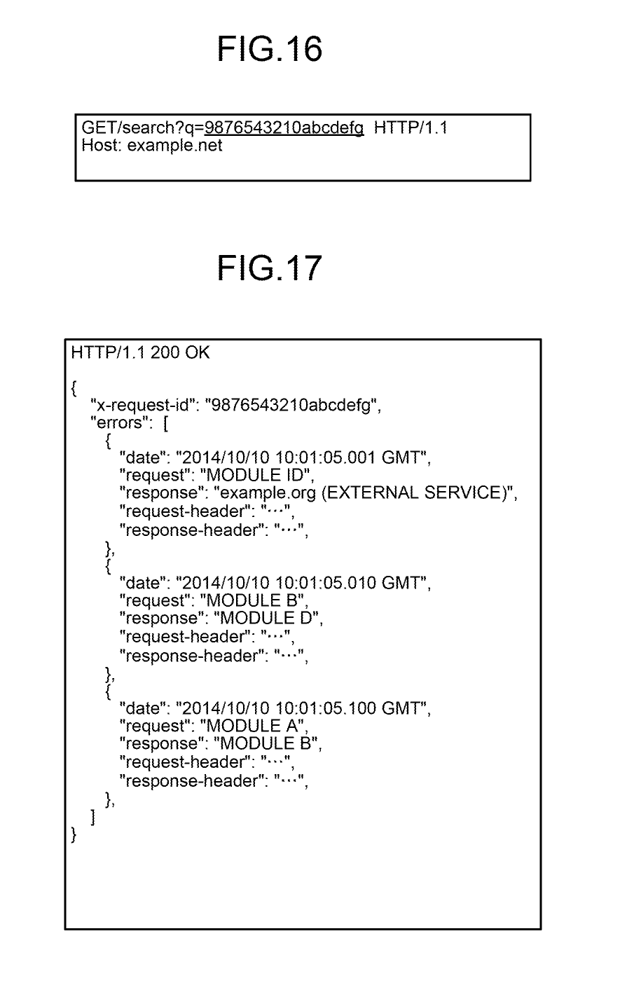

For example, in the case of the example illustrated in FIG. 15, the access result information of the access process called “acquire user information” indicates that the access has failed. This causes the searcher 1159 to search the memory system 1300 for one or more pieces of error information including the X-Request-ID used in the access process called “acquire user information”. The X-Request-ID is included in a request header included in the error information. FIG. 16 illustrates an example of a search request that is used in this search and sent to the memory system 1300 by the searcher 1159. As a result of this search request, the searcher 1159 obtains the three pieces of the error information illustrated in FIG. 15. FIG. 17 illustrates an example of a search response to the search request illustrated in FIG. 16.

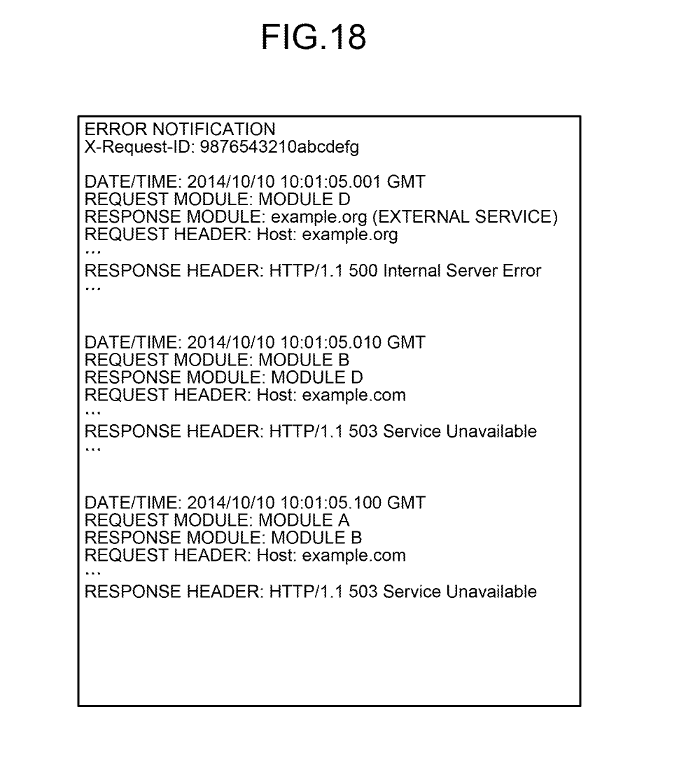

The output unit 1157 further performs output based on the pieces of error information found by the searcher 1159. For example, the output unit 1157 generates error notification information obtained by forming the search response illustrated in FIG. 17 in the chronological order of occurrence of the error information, as illustrated in FIG. 18, and sends the notification information to e-mail addresses of operators and analysts of the system 1010. The e-mail addresses of operators and analysts of the system 1010 are assumed to be stored in the storage unit 1140. Because the error notification information is formed in the chronological order of occurrence of the error information, the operators and the analysts can easily understand where the errors have occurred (the processor 1002 or the external system 1200 that caused the errors). The notification based on the error information may be a notification of an update of an RDF Site Summary (RSS) or a notification to Internet Relay Chat (IRC).

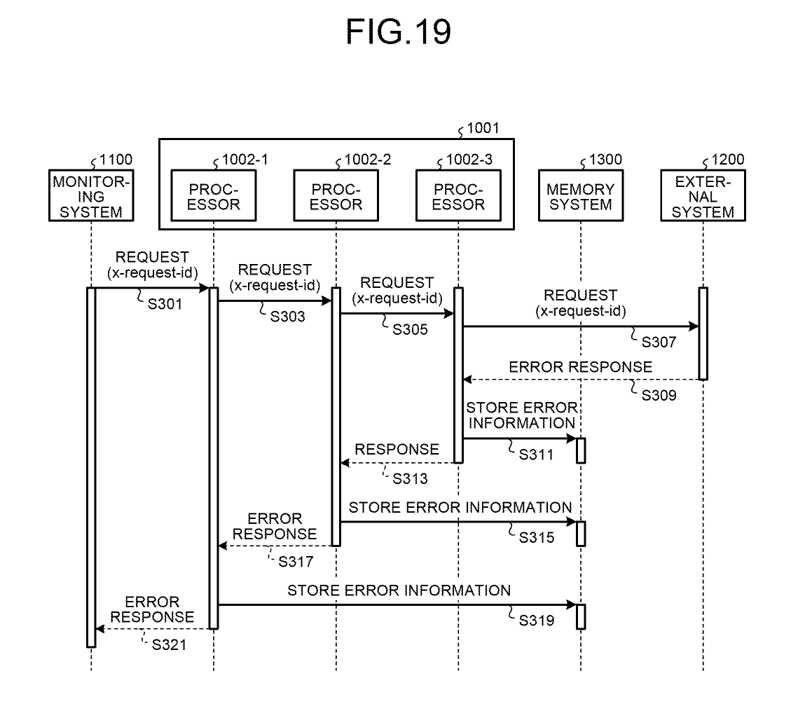

FIG. 19 is a sequence diagram illustrating an example of access processes performed by the system 1010 according to the second embodiment. The example illustrated in FIG. 19 will be described as an example in which the error information illustrated in FIG. 15 is stored in the memory system 1300 as a result of the processes.

First, the access unit 1151 generates an X-Request-ID, adds it to an HTTP request stored in the storage unit 1140, and issues the HTTP request called “acquire user information” (Step S301).

Then, based on the HTTP request received from the monitoring system 1100, the processor 1002-1 generates an HTTP request for dealing with the received HTTP request, adds the X-Request-1D included in the HTTP request from the monitoring system 1100 to the generated HTTP request, and issues the HTTP request with the X-Request-1D added thereto to the processor 1002-2 (Step S303).

Then, based on the HTTP request received from the processor 1002-1, the processor 1002-2 generates an HTTP request for dealing with the received HTTP request, adds the X-Request-ID included in the HTTP request from the processor 1002-1 to the generated HTTP request, and issues the HTTP request with the X-Request-ID added thereto to the processor 1002-3 (Step S305).

Then, based on the HTTP request received from the processor 1002-2, the processor 1002-3 generates an HTTP request for dealing with the received HTTP request, adds the X-Request-ID included in the HTTP request from the processor 1002-2 to the generated HTTP request, and issues the HTTP request with the X-Request-ID added thereto to the external system 1200 (Step S307).

The processor 1002-3 then acquires an HTTP response to the HTTP request issued to the external system 1200 from the external system 1200 (Step S309). In this case, the HTTP response is assumed to be an error response as described in the example illustrated in FIG. 15.

Because the HTTP response is an error response, the processor 1002-3 stores, in the memory system 1300, error information in which the header of the HTTP response, the header of the HTTP request, the transmission source information indicating the processor 1002-3, and the transmission destination information indicating the external system 1200 are associated with one another (Step S311).

The processor 1002-3 then returns the error response as an HTTP response to the processor 1002-2 (Step S313).

Because the HTTP response is an error response, the processor 1002-2 stores, in the memory system 1300, error information in which the header of the HTTP response, the header of the HTTP request, the transmission source information indicating the processor 1002-2, and the transmission destination information indicating the processor 1002-3 are associated with one another (Step S315).

The processor 1002-2 then returns the error response as an HTTP response to the processor 1002-1 (Step S317).

Because the HTTP response is an error response, the processor 1002-1 stores, in the memory system 1300, error information in which the header of the HTTP response, the header of the HTTP request, the transmission source information indicating the processor 1002-1, and the transmission destination information indicating the processor 1002-2 are associated with one another (Step S319).

The processor 1002-1 then returns the error response as an HTTP response to the monitoring system 1100 (Step S321).

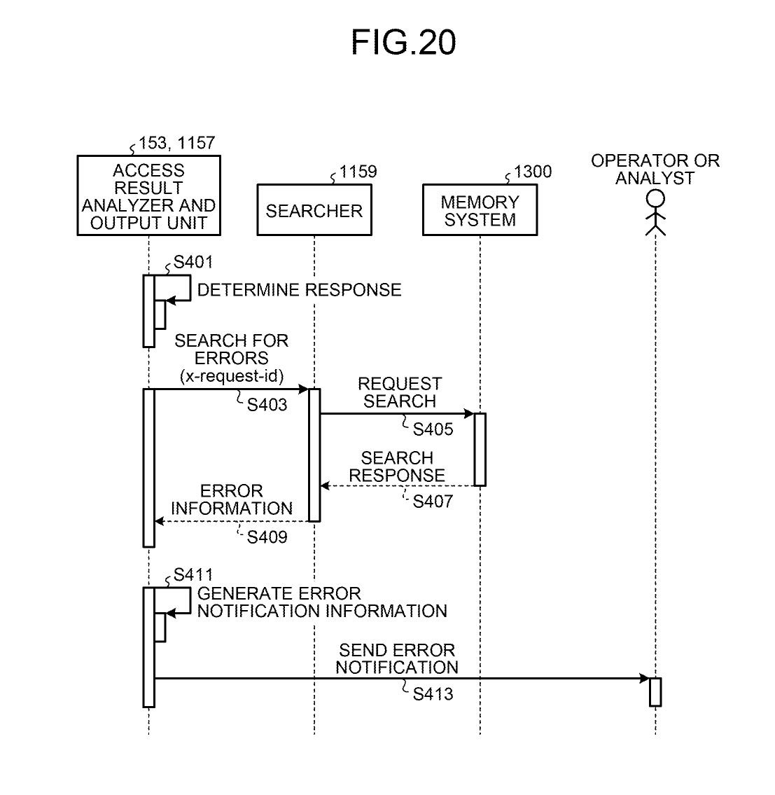

FIG. 20 is a sequence diagram illustrating an example of the search and the output processes performed by the monitoring system 1100 according to the second embodiment.

First, the access result analyzer 153 determines whether any of the pieces of access result information (the HTTP response or any of the HTTP responses) indicates that an access has failed (Step S401). In this case, one piece of the access result information is assumed to indicate that the access has failed.

Then, the access result analyzer 153 notifies the searcher 1159 of the X-Request-1D added to the HTTP request in response to which the access result information indicates that the access has failed (Step S403).

Then, the searcher 1159 sends to the memory system 1300 a search request with the X-Request-1D thus notified of as a key (Step S405).

Then, using the sent X-Request-ID as a key, the memory system 1300 searches for error information that includes the X-Request-ID, and returns a search response that includes one or more pieces of error information found to the monitoring system 1100 (Step S407).

Then, the searcher 1159 returns the pieces of error information included in the returned search response to the output unit 1157 (Step S409).

Then, the output unit 1157 generates the error notification information by forming the pieces of error information returned (Step S411), and sends the notification information to the e-mail addresses of the operators and the analysts of the system 1010 (Step S413).

As described above, in the second embodiment, the monitoring system includes in an access process the access process identification information that can identify the access process; and each of the processors of the service providing system issues the processing request including the access process identification information notified of from a higher level unit to a lower level unit, and if the process has resulted in failure, stores the error information in which the processing request including the access process identification information, the processing result, the transmission source information, and the transmission destination information are associated with one another.

As a result, according to the second embodiment, by searching for the error information based on the access process identification information in the access process using the access process identification information, the user can know one or more processors in which an error has occurred, and can know a processor that has caused the error among the one or more processors, without performing a log analysis.

Modifications

The present invention is not limited to the above-described embodiments, but various modifications can be made.

Modification 1

In the second embodiment, the searcher 1159 may search the memory system 1300 for one or more pieces of error information including the access process identification information entered based on a user operation via the operation unit 120.

This allows the operators and the analysts of the system 1010 to search for, for example, past error information regardless of the result of the analysis by the access result analyzer 153, and thus can lead to finding of potential problems of the system 1010, such as detection of frequently occurring errors beforehand.

Modification 2

In the second embodiment, even if the result of the analysis by the access result analyzer 153 shows that no piece of the access result information indicates that the access has failed, the searcher 1159 may search the memory system 1300 for one or more pieces of error information including the access process identification information of an access process.

This can lead to the following. That is, for example, if the processor 1002 is designed to retry processing predefined times when the processor 1002 obtains a processing result indicating that the access has failed, and if the processing result finally indicates that the processing has been successful, the operators and the analysts of the system 1010 can obtain, for example, the results of processing that has failed until the access becomes successful.

Modification 3

In the second embodiment, the output unit 1157 may send an output based on the error information to the address of a person in charge of the processor 1002 that has caused the error information or the address of a person in charge of the external system 1200 that has caused the error information.

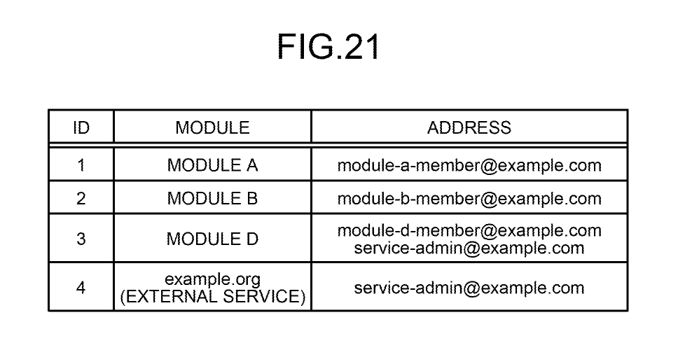

In this case, the storage unit 1140 only needs to store a table in which each of the processors (modules) or the external system (external service) is associated with the address of a person in charge thereof, as illustrated in FIG. 21, and the output unit 1157 only needs to send the output based on the error information to the address corresponding to the processor or the external system that has caused the error information.

In this manner, the error notification can be made on the processor or external system basis, whereby earlier responses can be expected.

Modification 4

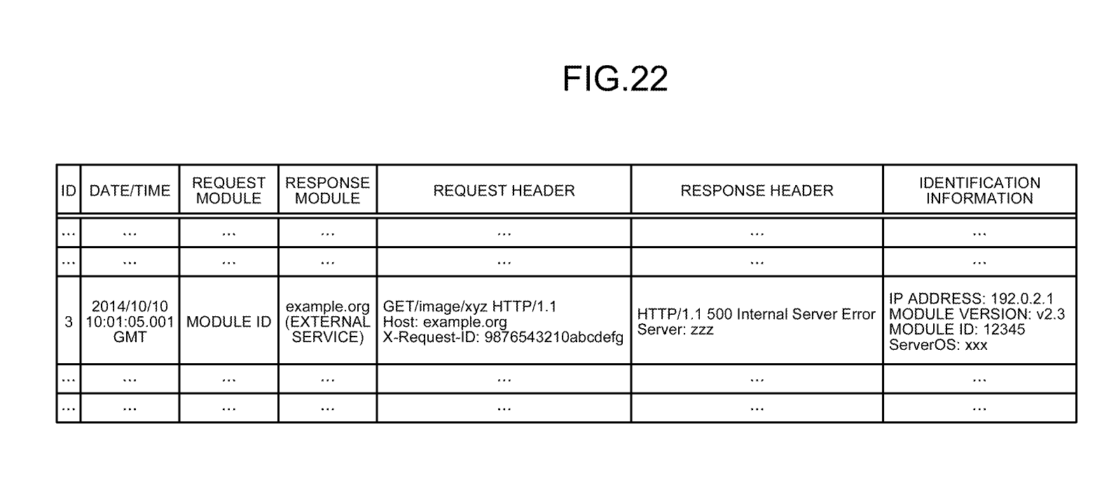

In the second embodiment, if the processing result indicates that the processing has failed, the processing result analyzer 1005 may store, in the memory system 1300, error information in which, in addition to the processing result, the processing request issued to obtain the processing result, the transmission source information, and the transmission destination information, identification information that can identify the processor that includes the processing result analyzer 1005, are associated with one another, as illustrated in FIG. 22. Examples of the identification information include, but are not limited to, IP addresses of servers including the processors, OS names of operating systems (OSs) including those of the processors, IDs of the processors, and version information of the processors.

This allows identification of a processor 1002 in which an error has occurred, even if the service providing system 1001 is built by redundantly configuring servers including the processors, such as by mirroring the servers, or if a server includes a plurality of processors 1002 of the same type.

Modification 5

In the second embodiment, instead of being included in each of the processors 1002, the processing result analyzer 1005 may be included in the service providing system 1001, and may analyze the processing result obtained by each of the processing requesters 1004; if the processing result indicates that the processing has failed, the processing result analyzer 1005 may store, in the memory system 1300, the error information in which the processing result, the processing request issued to obtain the processing result, the transmission source information indicating the transmission source of the processing request, and the transmission destination information indicating the transmission destination of the processing request are associated with one another.

This eliminates the need for each of the processors 1002 to include the processing result analyzer 1005, and thereby can improve maintainability. This also allows the processing result analyzer 1005 to asynchronously store the error information in the memory system 1300, which is preferable in terms of design.

Modification 6

In the second embodiment, the example has been described in which each of the processors 1002 synchronously issues the processing request. The second embodiment can, however, be applied to a case of asynchronously issuing the processing request, in which case a higher level processor 1002 accumulates processing requests in a storage unit (not illustrated), such as a queue, in the service providing system 1001, and a lower level processor 1002 sequentially deals with the processing requests accumulated in the storage unit.

Hardware Configuration

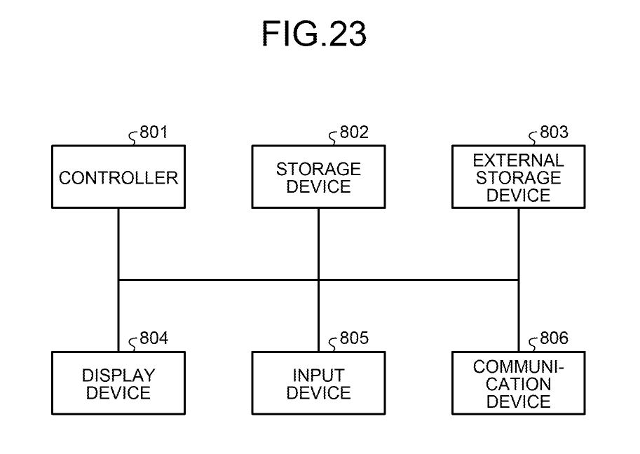

FIG. 23 is a diagram illustrating an example of the hardware configuration of the monitoring system, the service providing system, the external system, and the memory system 1300 according to the above-described embodiments (hereinafter, called “each system of the embodiments”). Each system of the embodiments includes a controller 801 such as a CPU, storage devices 802 such as a ROM and a RAM, an external storage device 803 such as an HDD, a display device 804 such as a display, input devices 805 such as a keyboard and a mouse, a communication device 806 such as a communication interface (I/F), and has a hardware configuration using an ordinary computer.

Computer programs to be executed in each system of the embodiments are stored as files in an installable format or an executable format on a computer-readable storage medium or media, such as one or more CD-ROMs, CD-Rs, memory cards, digital versatile discs (DVDs), or flexible disks (FDs).

The computer programs to be executed in each system of the embodiments may be stored on a computer connected to a network, such as the Internet, and may be provided by being downloaded via the network. The computer programs to be executed in each system of the embodiments may be provided or delivered via a network, such as the Internet. The computer programs to be executed in each system of the embodiments may be provided by being installed in advance in a ROM or the like.

The computer programs to be executed in each system of the embodiments are configured in modules for implementing the above-described units on a computer. As actual hardware, the CPU reads the computer programs from the HDD to load and execute them in the RAM, so that the above-described units are implemented on the computer.

The present invention has an effect of enabling direct monitoring of whether a service can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A monitoring system comprising:
an access unit that accesses, based on access data that defines an order of one or more access processes necessary for receiving a service and access information used in the respective access processes, a service providing system that provides the service, and acquires access results of the respective access processes;
an access result analyzer that analyzes the access results, and generates access result information on the respective access processes;
a creator that creates, based on the pieces of access result information, a report on whether the service is capable of being provided; and
an output unit that outputs the report.

2. The monitoring system according to claim 1, wherein the access result analyzer determines whether each of the access results corresponds to a predefined access result, and, if the access result corresponds to the predefined access result, generates the access result information indicating that the access has been successful, or, if the access result does not correspond to the predefined access result, generates access result information indicating that the access has failed.

3. The monitoring system according to claim 2, wherein the access result information indicating that the access has failed includes a reason for access failure based on a determination result of comparison between the acquired access result and the predefined access result.

4. The monitoring system according to claim 1, wherein the creator creates the report in which the pieces of access result information are arranged in chronological order.

5. The monitoring system according to claim 4, wherein the report indicates that the service is capable of being provided if the pieces of access result information include no access result information indicating that the access has failed, or indicates that the service is incapable of being provided if the pieces of access result information include the access result information indicating that the access has failed.

6. The monitoring system according to claim 4, wherein, if the pieces of access result information include the access result information indicating that the access has failed, the creator creates the report in which the access result information indicating that the access has failed is emphasized.

7. The monitoring system according to claim 1, wherein the service is a cloud service.

8. A system comprising:
the monitoring system according to claim 1; and
the service providing system, wherein
the access unit generates access process identification information that identifies an access process, and performs the access process using the access process identification information and the access information used in the access process,
the service providing system comprises a plurality of processors having a hierarchical structure,
each of the processors comprises:
an acceptor that accepts an access process from the monitoring system or accepts a processing request from one of the processors positioned at a higher hierarchy level than the acceptor;
a processing requester that issues, based on the access process or the processing request accepted by the acceptor, a processing request including the access process identification information included in the access process or the processing request accepted by the acceptor to one of the processors positioned at a lower hierarchy level than the processing requester or to an external system, and obtains a processing result; and
a processing result analyzer that analyzes the processing result, and if the processing result indicates that the processing has failed, stores, in an error storage unit, error information in which the processing result, the processing request issued to obtain the processing result, transmission source information indicating a transmission source of the processing request, and transmission destination information indicating a transmission destination of the processing request are associated with one another,
the monitoring system further comprises a searcher that searches the error storage unit for one or more pieces of error information associated with the access process identification information, and
the output unit further performs output based on the one or more pieces of error information.

9. The system according to claim 8, wherein, if any of the one or more pieces of access result information indicates that the access has failed, the searcher searches the error storage unit for one or more pieces of error information including the access process identification information of the access process whose access result information indicates that the access has failed.

10. The system according to claim 8, wherein the searcher searches the error storage unit for one or more pieces of error information including the access process identification information entered based on a user operation.

11. The system according to claim 8, wherein the output unit sends an output based on the error information to an address of a person in charge of a processor that has caused the error information or an address of a person in charge of the external system that has caused the error information.

12. The system according to claim 8, wherein the error information further includes identification information that is capable of identifying a processor that includes the processing result analyzer that has stored the error information in the error storage unit.

13. A system comprising:
the monitoring system according to claim 1; and
the service providing system, wherein
the access unit generates access process identification information that identifies an access process, and performs the access process using the access process identification information and the access information used in the access process,
the service providing system comprises a plurality of processors having a hierarchical structure,
each of the processors comprises:
an acceptor that accepts an access process from the monitoring system or accepts a processing request from one of the processors positioned at a higher hierarchy level than the acceptor; and
a processing requester that issues, based on the access process or the processing request accepted by the acceptor, a processing request including the access process identification information included in the access process or the processing request accepted by the acceptor to one of the processors positioned at a lower hierarchy level than the processing requester or to an external system, and obtains a processing result,
the service providing system further comprises a processing result analyzer that analyzes the processing result obtained by each of the processing requesters, and if the processing result indicates that the processing has failed, stores, in an error storage unit, error information in which the processing result, the processing request issued to obtain the processing result, transmission source information indicating a transmission source of the processing request, and transmission destination information indicating a transmission destination of the processing request are associated with one another,
the monitoring system further comprises a searcher that searches the error storage unit for one or more pieces of error information associated with the access process identification information, and
the output unit further performs output based on the one or more pieces of error information.

14. A monitoring method comprising:
accessing, based on access data that defines an order of one or more access processes necessary for receiving a service and access information used in the respective access processes, a service providing system that provides the service to acquire access results of the respective access processes;
analyzing the access results to generate access result information on the respective access processes;
creating, based on the pieces of access result information, a report on whether the service is capable of being provided; and
outputting the report.
